(19) United States
(12) Patent Application Publication
(10) Pub. No.: US 2008/0121200 A1
(43) Pub. Date: May 29, 2008

(54) PLASMA TYPE IGNITION PLUG

(75) Inventors: Hideyuki Kato, Nishio-shi (JP); Tohru Yoshinaga, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/942,902

(22) Filed: Nov. 20, 2007

(30) Foreign Application Priority Data
Nov. 24, 2006 (JP) 2006-316677
May 25, 2007 (JP) 2007-138824

(51) Int. Cl. F02P 23/04; F02P 9/00

(52) U.S. Cl. 123/143 B; 123/594; 313/141

(57) ABSTRACT

A plasma type ignition plug for igniting an internal combustion engine is disclosed having a negative electrode, a positive electrode, and a discharging distance fixing member, which includes an electrically conductive material replenishing section, made of an electrically conductive material available to melt when subjected to a heat of gas in plasma state, and an electrically conductive material replenished section to which the electrically conductive material is replenished. The discharging distance fixing member is covered on a surface of the negative electrode for initiating the spark discharge between a surface of the discharging distance fixing member and the positive electrode so as to avoid a fluctuation in a spark discharge distance caused by a wear of the negative electrode due to a collision of gas in the plasma state.

### CROSS REFERENCE TO RELATED APPLICATIONS

This application is related to Japanese Patent Applications No. 2006-316677, filed on Nov. 24, 2006, and No. 2007-138824, filed on May 25, 2007, the contents of which are hereby incorporated by reference.

### BACKGROUND OF THE INVENTION

1. Field of the Invention

The present invention relates to ignition plugs for internal combustion engines and, more particularly, to a technology of addressing a wear of an electrode forming part of a plasma type ignition plug for use in an ignition of an internal combustion engine.

2. Description of the Related Art

In an internal combustion engine of the related art such as an automotive engine, an attempt has heretofore been made to use a normal spark plug 1F operative to be activated by an ignition circuit shown in FIG. 15A. With such an ignition circuit, as an ignition switch 3 is turned on, a battery 2 applies a low voltage as a primary voltage across a primary coil 41 of an ignition coil 4. At the same time, an electronic control unit (ECU) 6 controllably turns on and off an igniter (transistor) 5 for switching the same to shut off the primary voltage. This results in a change in a magnetic field in the ignition coil 4, causing a secondary coil 42 of the ignition coil 4 to generate a secondary voltage with −10 to −30 kV. When this takes place, a spark discharge SDF occurs between a center electrode 110F and a ground electrode 154F, thereby generating a high temperature region HTR forming an ignition source within a narrow range as shown in FIG. 153B.

Another attempt has heretofore been made to use a plasma type ignition plug 1E operative to be activated by an ignition circuit shown in FIG. 14A. With such an ignition circuit, as an ignition switch 3 is turned on, a battery 2 applies a low voltage as a primary voltage across a primary coil 41 of an ignition coil 4. At the same time, an electronic control unit (ECU) 6 controllably turns on and off an igniter (transistor) for switching the same to shut off the primary voltage. This results in a change in a magnetic field in the ignition coil 4, causing a secondary coil 42 of the ignition coil 4 to generate a secondary voltage with −10 to −30 kV. When this takes place, a spark discharge occurs between a center electrode 110F and a ground electrode 154E, thereby generating a volume of plasma gas PGE at a high temperature in a highly pressurized region as shown in FIG. 14B. When this takes place, a discharge voltage reaches a level proportional to a discharging distance 201 between the center electrode 110E and the ground electrode 154E. At a time instant when the spark discharge begins to occur, energy (of, for instance, −450V at 120 A), stored in a capacitor bank 9 from a plasma energy supply battery 11 provided separately of the battery 2, is released to the discharging airspace 200E at once. This causes a volume of gas in the discharging airspace 200E to be formed into plasma gas PGE in a plasma state at a high temperature and high pressure, which is ejected from an opening portion 155E formed at a leading end portion of the discharging airspace 200E. This results in the occurrence of a high temperature region in a wide range with an increased directivity.

Therefore, with a view to causing a dilute fuel mixture to be combusted in a direct fuel-injection engine, such a plasma type ignition plug has an expected application to a stratified combustion in which a rich fuel mixture is arranged to gather around the ignition plug in the vicinity thereof for achieving easy combustion.

U.S. Pat. No. 3,581,141 discloses a surface gap spark plug as such a plasma type ignition plug. With such a related art, the surface gap spark plug includes a center electrode, an insulating body having a center at which the center electrode is concentrically held and having a longitudinally extending insertion bore, and a ground electrode covering the insulating body and having a lower end formed with an opening portion in communication with the insertion bore with a spark discharge gap being formed inside the insertion bore.

With such a plasma type ignition plug of the related art, as shown in FIG. 14B, the center electrode 110E serves as a negative electrode with a bottom surface exposed to the spark discharge gap. In operation, cations 20E with large masses impinge upon the bottom surface of the center electrode 110E, causing a cathode sputtering phenomenon to occur in which the bottom surface of the center electrode 110E is gradually decomposed causing a progressive erosion of the center electrode 110E. This results in a gradual increase in distance between the center electrode 110E and the ground electrode 154E. That is, the spark discharge distance 201 progressively increases as shown by an arrow L1, causing an increase in discharge voltage.

Accordingly, a long-term usage results in a difficulty of initiating the spark discharge with a fear of causing a misfiring of the internal combustion engine.

### SUMMARY OF THE INVENTION

The present invention has been completed with the above view in mind and has an object to provide a plasma type ignition plug, having a negative electrode with a less wear when subjected to cathode sputtering, which has a less occurrence of an increase in a discharge voltage while realizing a stable ignition with a superior durability.

To achieve the above object, a first aspect of the present invention provides a plasma type ignition plug for igniting an internal combustion engine, comprising: a cylindrical ground electrode having a leading end whose bottom portion has a central area formed with an opening portion; a cylindrical insulating body, kept in abutting contact with an inside of the ground electrode and engaging the bottom portion of the ground electrode, which has an inner diametric portion defining a discharging airspace in communication with the opening portion of the ground electrode; and a center electrode fitted to the insulating body at a center thereof and having a leading end exposed to the discharging airspace at a position axially inward from a leading end face of the ground electrode. One of the ground electrode and the center electrode serves as a negative electrode and the other serves as a positive electrode. A voltage is applied across the ground electrode and the center electrode to initiate a spark discharge in the discharging airspace formed inside the insulating body to allow gas in the discharging airspace to eject from the opening portion of the ground electrode in a plasma state at a high temperature and high pressure for achieving an ignition in the internal combustion engine. A discharging distance fixing member, including an electrically conductive material replenishing section, made of an electrically conductive material available to melt when subjected to a heat of the gas in the plasma state, and an electrically conductive material replenished section to which the electrically conductive material is replenished, is covered on a surface of is the negative electrode for initiating the spark discharge between a surface of the discharging distance fixing member and the positive electrode so as to avoid a fluctuation in a spark discharge distance caused by a wear of the negative electrode due to a collision of gas in the plasma state.

With the plasma type ignition plug of such a structure, a part of the electrically conductive material replenishing section becomes a melted state and the melted electrically conductive material infiltrates and diffuses into the electrically conductive material replenished section. This enables the electrically conductive material to be replenished to the surface of the discharging distance fixing member in an area eroded due to cathode sputtering. Thus, a discharging distance between the negative electrode and the positive electrode can be kept in a fixed state at all times.

Accordingly, the plasma type ignition plug has increased durability.

With the plasma type ignition plug of the present embodiment, the discharging distance fixing member may be preferably located such that the discharging airspace and the electrically conductive material replenished section are adjacent to each other and the electrically conductive material replenishing section and the electrically conductive material replenished section are adjacent to each other.

With the plasma type ignition plug of such a structure, even if the surface of the electrically conductive material replenished section is eroded in an area exposed to the discharging airspace due to cathode sputtering, the eroded surface of the electrically conductive material replenished section is replenished with electrically conductive material from the neighboring of the electrically conductive material replenishing section. This enables the discharging distance between the negative electrode and the positive electrode to be kept in the fixed state at all times.

Accordingly, the plasma type ignition plug has increased durability.

With the plasma type ignition plug of the present embodiment, the electrically conductive material replenished section may preferably comprise a sintered mixture body between an insulating material and an electrically conductive material.

With such a structure mentioned above, the insulating material has a grain boundary formed with the electrically conductive material layer. Therefore, even if the surface of the electrically conductive material replenished section is eroded in the area exposed to the discharging airspace due to cathode sputtering, the electrically conductive material is replenished to the grain boundary of the insulating material from the electrically conductive material replenishing section. This ensures an electrical connection between the discharging distance fixing section and the negative electrode, enabling the discharging distance to be kept in the fixed state at all times.

Accordingly, the plasma type ignition plug has increased durability.

With the plasma type ignition plug of the present embodiment, the electrically conductive material replenished section may preferably comprise a multiple-micropore body having a large number of micropores extending from a surface of the electrically conductive material replenishing section to a surface exposed to the discharging airspace.

With the plasma type ignition plug of such a structure, a spark discharge occurs through the micropores with the electrically conductive material replenishing section having the surface being melted with the occurrence of cathode sputtering. In due time, the electrically conductive material remaining under the melted state or atoms of electrically conductive material, scattered upon cathode sputtering, adhere onto the insides of the micropores to infill the same with the electrically conductive material. This allows the spark discharge to occur on the surface of the electrically conductive material replenished section, enabling the discharging distance to be kept in the fixed state at all times.

Accordingly, the plasma type ignition plug has increased durability.

With the plasma type ignition plug of the present embodiment, the electrically conductive material replenished section may preferably comprise a porous body having a large number of irregularly shaped open voids.

With the plasma type ignition plug of such a structure, a spark discharge occurs through the irregularly shaped open voids with the electrically conductive material replenishing section having the surface being melted with the occurrence of cathode sputtering. In due time, the electrically conductive material remaining under the melted state or atoms of electrically conductive material, scattered upon cathode sputtering, adhere onto the insides of the irregularly shaped open voids to infill the same with the electrically conductive material. This allows the spark discharge to occur on the surface of the electrically conductive material replenished section, enabling the discharging distance to be kept in the fixed state at all times.

Accordingly, the plasma type ignition plug has increased durability.

With the plasma type ignition plug of the present embodiment, the electrically conductive material replenished section may be preferably made of at least one of an insulating material and an electrically conductive material with a high melting point.

With the plasma type ignition plug of such a structure, no spark discharge erodes the discharging distance fixing section on a surface facing the spark discharge, enabling the discharging distance to be fixed.

Accordingly, the plasma type ignition plug has increased durability.

With the plasma type ignition plug of the present embodiment, the large number of micropores may preferably have a shape formed in at least one of a circular shape, a hexagonal shape, square shape and a recessed shape.

With the plasma type ignition plug of such a structure, the multiple-micropore body can be easily shaped by a molding method such as extrusion forming, press forming or the like, enabling the realization of a plasma type ignition plug with increased durability.

With the plasma type ignition plug of the present embodiment, the electrically conductive material for use in the electrically conductive material replenishing section may preferably include at least one of a transition metallic material, selected from the group consisting of Pt, Au, Ag and Ni, and a compound of the transition metallic material.

With the plasma type ignition plug of such a structure, the electrically conductive material replenishing section is less liable to be oxidized, enabling the realization of a plasma type ignition plug with increased durability.

More particularly, the insulating material for use in the electrically conductive material replenished section may preferably include a ceramic material composed of at least one of Si₃N₄ and Al₂O₃.

Further, the electrically conductive material with the high melting point for use in the electrically conductive material replenished section may preferably include a HfC ceramic material.

The HfC ceramic material has electrical conductivity with likelihood of a slight wear but has a function, in addition to a function of the electrically conductive material replenished member, as an electrically conductive electrode material.

Using Pt, Ag and Au as replenishing electrically conductive material allows these materials to be replenished as the electrode material with priority because these materials have melting points lower than that of the HfC ceramic.

### BRIEF DESCRIPTION OF THE DRAWINGS

FIG. 1 is a view showing a structure with a part in cross section of a plasma type ignition plug of a first embodiment according to the present invention.

FIG. 2A is an equivalent circuit schematic for the plasma type ignition plug of the first embodiment according to the present invention utilized under a condition where a center electrode acts as a negative electrode.

FIG. 2B is another equivalent circuit schematic for the plasma type ignition plug of the first embodiment according to the present invention utilized under another condition where the center electrode acts as a positive electrode.

FIG. 3A is a plan view showing an outline of an electrically conductive material replenished section for use in the plasma type ignition plug of the first embodiment according to the present invention.

FIG. 3B is an enlarged cross-sectional view representing an essential part of the plasma type ignition plug of the first embodiment according to the present invention.

FIG. 4 is an enlarged cross-sectional view representing the essential part of the plasma type ignition plug of the first embodiment according to the present invention for illustrating an effect thereof.

FIGS. 5A to 5D show plan views and cross-sectional views each in combination for illustrating various modifications of the electrically conductive material replenished section shown in FIGS. 3A and 3B.

FIG. 6 is a view showing a structure with a part in cross section of a plasma type ignition plug of a modified form of the plasma type ignition plug of the first embodiment shown in FIG. 1.

FIG. 7A is a plan view showing an outline of an electrically conductive material replenished section for use in the plasma type ignition plug of the modified form shown in FIG. 6.

FIG. 7B is a plan view showing the relationship between the electrically conductive material replenished section and a ground electrode of the plasma type ignition plug of the modified form shown in FIG. 6.

FIG. 8 is an enlarged cross-sectional view representing the essential part of the plasma type ignition plug of the modified form, shown in FIG. 6, for illustrating an effect thereof.

FIG. 9 is a view showing a structure with a part in cross section of a plasma type ignition plug of a second embodiment according to the present invention.

FIG. 10 is an enlarged cross-sectional view representing an essential part of the plasma type ignition plug of the second embodiment according to the present invention shown in FIG. 9.

FIG. 11A is an exploded view of an electrically conductive material replenished section shown in FIG. 10.

FIGS. 11B and 11C are perspective views representing electrically conductive material replenished sections of modifications of the electrically conductive material replenished section shown in FIG. 11A.

FIG. 12 is a view showing a structure with a part in cross section of a plasma type ignition plug of a third embodiment according to the present invention.

FIGS. 13A to 13C show perspective views representing electrically conductive material replenished sections of various modifications for use in the plasma type ignition plug of the third embodiment shown in FIG. 12.

FIG. 14A is an equivalent circuit schematic showing an exemplary circuit structure for a plasma type ignition plug of the related art.

FIG. 14B is a cross-sectional view representing an outline of the plasma type ignition plug of the related art for explaining an issue encountered therewith.

FIG. 15A is an equivalent circuit schematic showing another exemplary circuit structure for a normal ignition plug of the related art.

FIG. 15B is an enlarged view showing an essential part of the normal ignition plug of the related art for explaining an issue encountered therewith.

### DETAILED DESCRIPTION OF THE PREFERRED EMBODIMENTS

Now, plasma type ignition plugs of various embodiments according to the present invention will be described below in detail with reference to the accompanying drawings. However, the present invention is construed not to be limited to such all embodiment described below and technical concepts of the present invention may be implemented in combination with other known technologies or the other technology having functions equivalent to such known technologies.

In the following description, like reference characters designate like or corresponding parts throughout the several views. In the following description, further, it is to be understood that such terms as “inner, “outer”, “lower”, “upper”, “inside”, “outside”, “toward”, “axial”, “axially”, “upstream”, “downstream” and the like are words of convenience and are not to be construed as limiting terms.

### First Embodiment

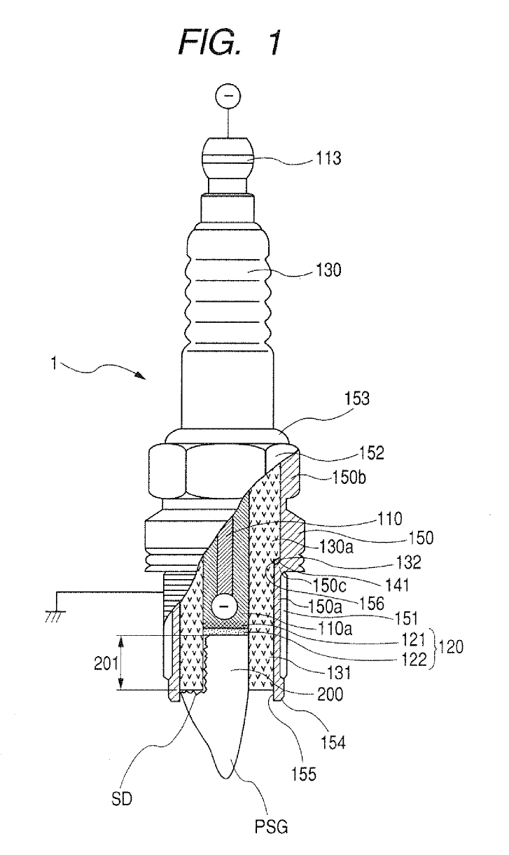

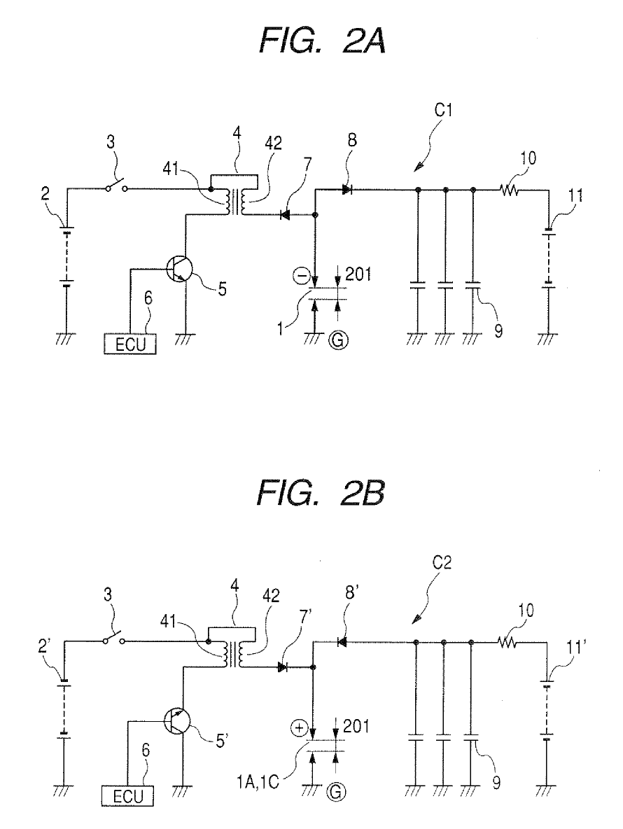

Now, a plasma type ignition plug of a first embodiment according to the present invention for use in an internal combustion engine will be described below in detail with reference to FIGS. 1 and 2.

FIG. 1 is a partially cross-sectional view showing an outline of the plasma type ignition plug of the first embodiment according to the present invention.

FIG. 2A is a circuit diagram showing one example of fundamental structures of the plasma type ignition plug of the first embodiment according to the present invention with a center electrode acting as a negative electrode. FIG. 2B is a circuit diagram showing the other example of the fundamental structures of the plasma type ignition plug of the first embodiment according to the present invention with the center electrode acting as a positive electrode.

As shown in FIG. 1, the plasma type spark plug 1 of the present embodiment comprises the center electrode 110 made of conductive metallic material and formed in a columnar shape. The center electrode 110 has a base end, electrically connected to a center electrode terminal 113 for electrical connection to an external power distribution source, and a leading end 110a including a discharging distance fixing member 120. The discharging distance fixing member 120 includes an electrically conductive material replenishing section 121, formed on the leading end 110a of the center electrode 110, and an electrically conductive material replenished section 122 formed on the electrically conductive material replenishing section 121 in an area in opposition to the leading end 110a.

The center electrode 110 and the discharging distance fixing member 120 are held with a cylindrical porcelain insulator 130 axially extending through the metal shell 150 in a coaxial relationship therewith for insulating capability. The porcelain insulator 130 has a leading end portion 131, formed in a cylindrical sleeve shape, which axially extending downward from a distal end of the discharging distance fixing member 120 to be away therefrom by a discharging distance 201 to define a discharge air space 200.

The discharging distance fixing member 120 has a laminar structure such that the electrically conductive material replenished section 122 faces the discharge air space 200 and the electrically conductive material replenishing section 121 and the electrically conductive material replenished section 122 face each other.

Further, the porcelain insulator 130 is covered with the cylindrical metal shell 150.

The cylindrical metal shell 150 has a leading end formed with a ground electrode 154, covering the leading end portion 131 of the porcelain insulator 130, which has a ground electrode opening portion 155.

Furthermore, the metal shell 150 has a leading end portion 150a having an outer circumferential periphery formed with a threaded portion 151 adapted to be screwed into and fixedly mounted on an engine head of an internal combustion engine (not shown) to provide an electrically grounded state. The metal shell 150 has a base end portion 150b having an outer circumferential periphery formed with a hexagonal nut portion 152 for tightening the threaded portion 151 onto the engine head.

The porcelain insulator 130 has an intermediate portion 130a having an outer circumferential periphery formed with an annular engaging abutment portion 132. Meanwhile, the metal shell 150 has an intermediate portion 150c having an inner circumferential periphery formed with an annular engaging shoulder 141 facing the annular engaging abutment portion 132 of the porcelain insulator 130. A packing washer 141 is interposed between the annular engaging abutment portion 132 of the porcelain insulator 130 and the annular engaging shoulder 141 of the metal shell 150, upon which a caulking portion 153, formed on top of the metal shell 150, is caulked via a sealing member or the like (not shown) to tightly hold the packing washer 141 to provide a hermetic sealing effect.

In an alternative, the plasma type ignition plug 1 of the present embodiment may be preferably altered such that the electrically conductive material replenishing section 121 and the electrically conductive material replenished section 122 are bonded to each other in a unitary structure by welding or the like after which the unitary structure is fitted to the porcelain insulator 131. In another alternative, the porcelain insulator 131 may preferably have an inner circumferential periphery formed with a small diameter engaging abutment portion to which the electrically conductive material replenishing section 121 and the electrically conductive material replenished section 122 are sequentially inserted in fitting engagement.

As shown in FIG. 2A, the plasma type ignition plug 1 of the present embodiment is connected to the ignition circuit C1. The ignition circuit C1 includes a battery 2 acting as a discharging ignition power supply, an ignition switch 3, an ignition coil 4, an electronic control unit (ECU) 6, an igniter 5, composed of a transistor, and a rectifier element 7. The ignition circuit C1 further includes a battery 11 acting as a plasma energy supply power source, a resistor 10, a capacitor bank 9 and a rectifier element 8, which are electrically connected to the plasma type ignition plug 1 of the present embodiment such that the center electrode 110 serves as a negative electrode.

In operation, as the ignition switch 3 is turned on, a primary voltage with a low voltage level is applied from the battery 2 to a primary coil 41. When this takes place, the electronic control unit (ECU) 6 turns on and off the igniter 6 in switching states for shutting off the primary voltage. This causes a magnetic field inside the ignition coil 4 to vary, causing a secondary coil 42 of the ignition coil 4 to generate a secondary voltage at a level ranging from −10 to −30 kV. This secondary voltage, applied to the center electrode 110 of the plasma type ignition plug 1, reaches a discharge voltage proportionate to the discharging distance 201 between the center electrode 110 and the ground electrode 154, commencing an electrical spark discharge.

In this instance of time, the plasma energy supply power source 11, provided separately of the battery 2, supplies electric energy (of, for instance, −450V with 120 A) from the capacitor bank 9 to the discharging space 200 at once. This causes a bulk of gas, prevailing inside the discharging space 200, to be formed into a plasma state gas PS with a high temperature and high pressure. The plasma state gas PS is injected from the opening portion 155, formed at a distal end of the discharging space 200, into a combustion chamber (not shown) of the engine. This plasma state gas PS has a highly-directivity and forms a high temperature region in a wide range in volume.

FIG. 2B shows an ignition circuit C2 of another type including the same fundamental structure as that of the ignition circuit C1, shown in FIG. 2A, except in that a battery 2′ acting as a discharging ignition power supply, an igniter 5′, a rectifier 7′, a plasma energy supply power source 11′ and a rectifier element 8′ are electrically connected to allow the center electrode 110 of the plasma type ignition plug 1 to play a role as a positive electrode. This circuit structure is applied to plasma type ignition plugs 1A and 1C of second and third embodiments according to the present invention, respectively.

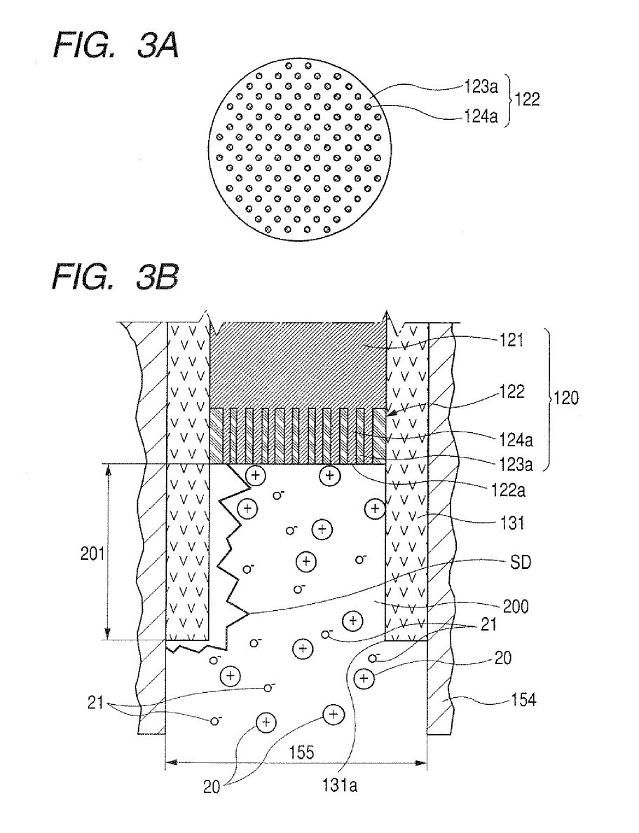

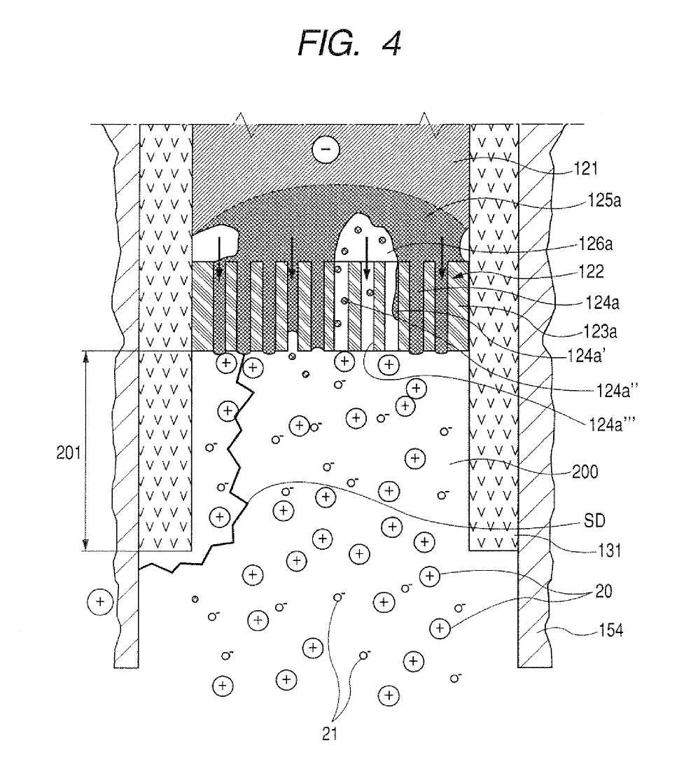

FIGS. 3A and 3B and FIG. 4 show results of the plasma type ignition plug 1 of the first embodiment according to the present invention.

As shown in FIGS. 3A and 3B, with the plasma type ignition plug 1 of the present embodiment, the conductive material replenished section 122 includes a circular disc multiple-micropore body 123a formed with multiple micropores 124a, axially extending therethrough, which have top ends in contact with the conductive material replenishing section 121 and bottom ends exposed to the discharging space 200.

For instance, the multiple-micropore body 123a is made of ceramic material such as Si₃N₄ and Al₂O₃ or the like and the micropores 124a are filled with metallic material such as Ni, Fe, Pt, Au, Ag or the like with high withstanding resistance to cathode sputtering or electrically conductive ceramic such as TiN and MoSiO₂ or the like.

The conductive material replenished section 122 may be preferably made of insulating material composed of, for instance, either one of ceramic materials such as Si₃N₄ and Al₂O₃ or the like with no wear being observed on an evaluation test specifically conducted on durability.

When applied with the high negative voltage, an electrical spark discharge occurs in the discharging space 200 on a surface discharge SD. FIG. 3B shows an instant of time in which the spark discharge occurs in the discharging space 200 causing a was mixture, composed of air and fuel gas, to be formed in a plasma state.

As shown in FIG. 3B, a surface 122a of the electrically conductive material replenished section 122 forming the discharging distance fixing member 120, the leading end portion 131 of the porcelain insulator 130, and the ground electrode 154 form the discharging space 200. The discharging distance fixing member 120 takes the form of a laminar structure formed with the electrically conductive material replenishing section 121 and the electrically conductive material replenished section 122 with the surface 122a thereof being exposed to the discharging space 200.

The electrically conductive material replenishing section 121 is made of electrically conductive material with hard-oxidizing property and low electric resistance such as, for instance, Ag, Au, Pt or the like.

As shown in FIG. 3B, the electrically conductive material replenishing section 121 and the micropores 124a are held in an electrically conducting state. The surface discharging SD occurs between surfaces of the micropores 124a and the ground electrode 154 so as to creep on an inner surface of the leading end portion 131 of the porcelain insulator 130. When this takes place, a large amount of electrons 21 are discharged into the discharging space 200 to cause nitrogen ions to become cations 20 such that the gas mixture is formed in the plasma state with neutral electricity under a high temperature and high pressure.

Moreover, the ground-electrode opening portion 155 may preferably have an opening with the same inner diameter as that of an opening diameter 131a of the leading end portion 131 of the porcelain insulator 130. In an alternative, the ground-electrode opening portion 155 may preferably have an opening larger in diameter than that of the opening diameter 131a of the leading end portion 131 of the porcelain insulator 130 to be nearly equal to an outer diameter of the leading end portion 131 of the porcelain insulator 130.

As the plasma type ignition plug 1 continues repetitive arc discharges over a prolonged period of time in use, the cations 20 such as, for instance. N⁺ ions or the like impinge upon the surfaces of the micropores 124a with a resultant occurrence of a cathode sputtering as shown in FIG. 4. This causes the micropores 124a to be eroded with a resultant occurrence of voids 126a. Therefore, a spark discharge occurs between the ground electrode 154 and one of the large number of micropores 124a of the multiple-micropore body 123a in an area exposed to the surface of the discharging airspace 200 at a position closest to the ground electrode 154. Therefore, the discharging distance 201 is maintained in a fixed range at all times, with no occurrence of an increase in discharge voltage.

Further, even if the surfaces of the micropores 124a are eroded due to the occurrence of cathode sputtering to cause the inner surfaces of the micropores 124a of the multiple-micropore body 123a to be exposed, the electrically conductive material replenishing section 121 are partially melted to form electrically conductive material 124a′ prevailing in a melted condition to infill the micropores 124a′″ in the form of voids. In addition, electrically conductive material 124a″, sputtered on the surface of the multiple-micropore body 123a, is deposited again.

Thus, electrically conductive material is replenished from the electrically conductive material replenishing section 121 to the electrically conductive material replenished section 122. This allows the surface of the multiple-micropore body 123a to be formed with the micropores 124a in conducting state with the electrically conductive material replenishing section 121 such that the discharging distance 201 is maintained in a fixed value at all times.

Further, like the micropore 124a′″, if the micropore 124a is unfilled with electrically conductive material since the beginning, a spark discharge begins to occur passing through the micropore 124a, causing the surface of the electrically conductive material replenishing section 121 to be eroded due to the occurrence of cathode sputtering. In due course, the micropore 124a is filled with electrically conductive materials 125a and 124a′, formed in melted states, or electrically conductive atom 124a″ scattered due to cathode sputtering. This allows the spark discharge to occur on the surface of the electrically conductive material replenished section 122, enabling the discharging distance to be fixed.

In an alternative, the multiple-micropore body 13a may be made of electrically conductive ceramic material with high melting point such as, for instance, HfC or the like in place of insulating ceramic material. Such ceramic has electrically conducting property and slightly worn but has a function as electrically conducting electrode material in addition to a function of an electrically conducting material replenishing member.

Using such high melting-point material allows electrically conducting material in the micropores 124a to be initially subjected to cathode sputtering. Thus, even if the multiple-micropore body 123a is made of electrically conducting material, the multiple-micropore body 123a is less eroded to have expectation with a nearly same advantageous effect as that in which insulating ceramic is used.

With the plasma type ignition plug of the present embodiment, a spark discharge can occur until the voids 126a, formed between the electrically conductive material replenishing section 121 and the electrically conductive material replenished section 122, completely separate the electrically conductive material replenishing section 121 and the electrically conductive material replenished section 122 from each other.

Pt, Ag and Au have lower melting points than that of HfC ceramic and, therefore, using such materials as replenishing electrically conducting material allows Pt, Ag and Au to be replenished as electrode material with high priority.

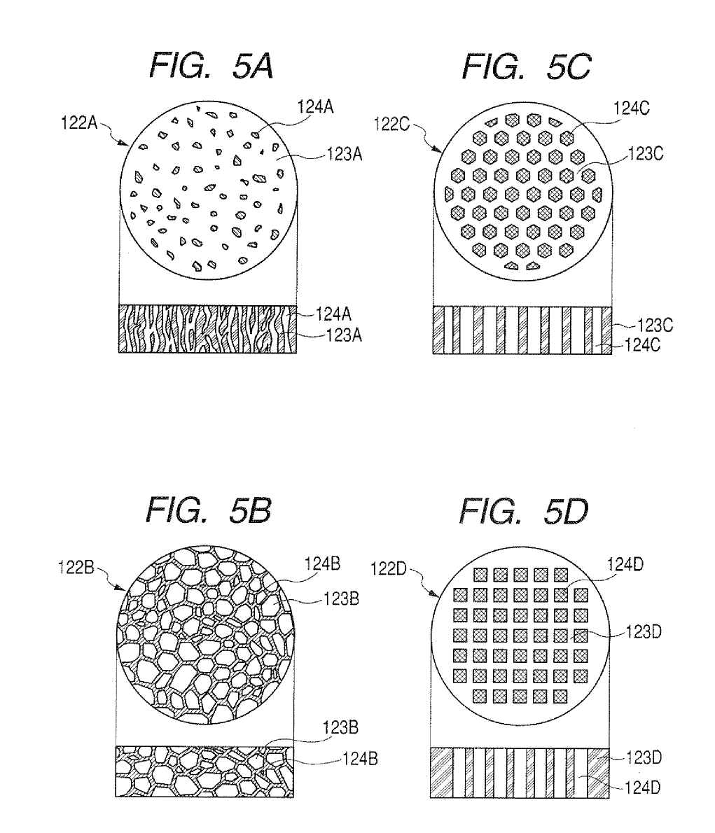

FIGS. 5A to 5D show conductive material replenished sections 122A, 122B, 122C and 122D of various modifications for use in the plasma type ignition plug 1 of the first embodiment according to the present invention.

The conductive material replenished sections 122A, 122B, 122C and 122D of various modifications have the same structures as the conductive material replenished section 122, shown in FIGS. 1 to 4, except for micropores formed in particular shapes. Thus, description will be made of these component parts with a focus on distinctive features.

As shown in FIG. 5A, the conductive material replenished section 122A includes a multiple micropore body 123A, made of insulating ceramic material such as, for instance, Si₃N₄ and Al₂O₃ or the like, which is formed with a large number of open holes extending in an axial direction.

Like the conductive material replenished section 122 of the first embodiment, the open holes 124A remain intact in opened states. In an alternative, the open holes 124A may be filled with conductive material such as, for instance, Ag, Au, Ni and Pt or the like or conductive ceramic material such as, for instance, TiN and MoSiO₂ or the like.

In another alternative, the multiple-micropore body 123A may be made of conductive ceramic material with a high melting point such as, for instance, HfC in place of insulating ceramic material.

With the plasma type ignition plug employing the conductive material replenished section 122A of the present modification, a spark discharge occurs between the open holes 124A, filled with conductive material, and the ground electrode 154 on a surface of the multiple-micropore body 123A exposed to the discharging space 200.

As shown in FIG. 5B, the conductive material replenished section 122B is comprised of a multiple-micropore body 123B formed in a mixed sintered body between insulating ceramic material such as, for instance, Si₃N₄ and Al₂O₃ or the like and electrically conductive ceramic material such as, for instance, TiN and MoSiO₂ or the like.

With such a structure of the conductive material replenished section 122B shown in FIG. 5B, insulating ceramic material forms a base material of the conductive material replenished section 122B as an insulating ceramic layer 123B. Further, electrically conductive ceramic material is present on the crystal grain boundary of the insulating ceramic layer 123B in the form of an electrically conductive ceramic layer 124B.

With the plasma type ignition plug employing the conductive material replenished section 122B of the present modification, even if the electrically conductive ceramic layer 124B is eroded due to cathode sputtering, the conductive material replenishing section 121 replenishes electrically conductive material in diffusion through the crystal grain boundary, enabling the discharging distance 201 to be maintained in a fixed range.

In an alternative, the multiple-micropore bodies 123A and 123B of the conductive material replenished sections 122A and 122B may be replaced by a honeycomb structure body 122C including a multiple-micropore body 123C formed with a plurality of axially extending hexagonal micropores 124C as shown in FIG. 5C. In another alternative, the electrically conductive material replenished sections 122A and 122B may include a honeycomb structure body 122D including a multiple-micropore body 123D having a plurality of square-shaped micropores 124D as shown in FIG. 5D.

In addition, as the micropores 124A and 124B have polygonal shapes, respectively, the electrically conductive materials, replenished to the conductive material replenished sections 122A and 122B, can have corner portions at which electrical fields concentrate with a resultant effect of a reduction in a discharge voltage. The drop in discharge voltage results in a sputtering force, thereby achieving a further reduction in a wear of a negative electrode.

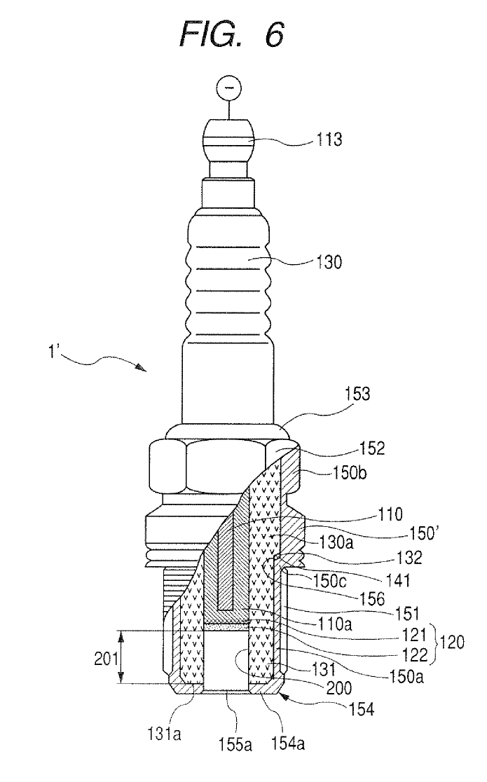

FIGS. 6 to 8 shows a plasma type ignition plug 1′ of a modified form of the first embodiment according to the present invention.

The plasma type ignition plug 1′ of the modified form has the same structure as that of the plasma type ignition plug 1 of the first embodiment with like or corresponding parts bearing like reference numerals and description will be made with a focus on a distinctive feature.

With the plasma type ignition plug 1′ of the modified form shown in FIGS. 6 to 8, the ground electrode 154 has a leading end formed with an annular electrode portion 154a radially extending inward from the leading end of the ground electrode 154 so as to cover the leading end face 131a of the porcelain insulator 130 such that an opening portion 155a has a diameter nearly equal to that of the discharging distance fixing section 120.

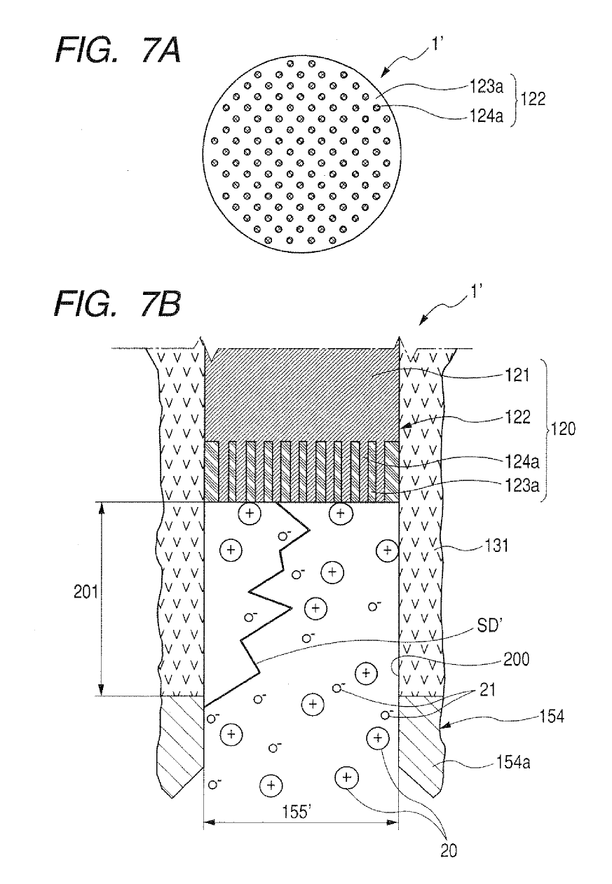

With the plasma type ignition plug 1′ of this modified form, as shown in FIG. 7B, the electrically conductive material replenishing section 121 and the micropore 124a are held in an electrically conductive state. With such a structure, a spark discharge SD′ occurs between the annular electrode portion 154a and a surface of the micropore 124a of the electrically conductive material replenished section 122.

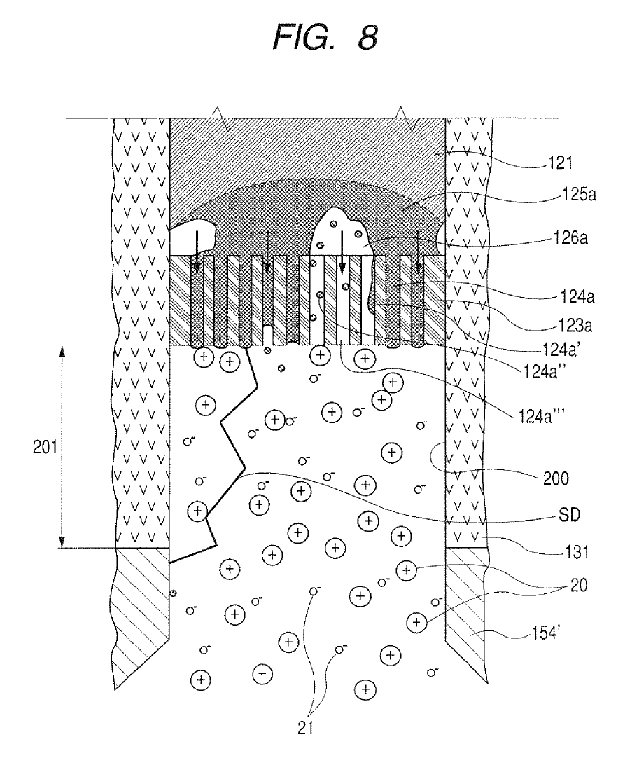

As the plasma type ignition plug 1′ continues repetitive arc discharges over a prolonged period of time in use, the cations 20 such as, for instance, N⁺ ions or the like impinge upon the surfaces of the micropores 124a with a resultant occurrence of a cathode sputtering as shown in FIG. 8. This causes the micropores 124a to be eroded with a resultant occurrence of voids 126a. Therefore, a spark discharge occurs between the annular electrode portion 154a of the ground electrode 154 and one of the large number of micropores 124a of the multiple-micropore body 123a in an area exposed to the surface of the discharging airspace 200 at a position closest to the annular electrode portion 154a of the ground electrode 154. Therefore, the discharging distance 201 is maintained in a fixed range at all times, with no occurrence of an increase in discharge voltage.

Further, even if the surfaces of the micropores 124a are eroded due to the occurrence of cathode sputtering to cause the inner surfaces of the micropores 124a of the multiple-micropore body 123a to be exposed the electrically conductive material replenishing section 121 is partially melted to form electrically conductive material 124a′ prevailing in a melted condition to infill the micropores 124a′″ in the form of voids. In addition, electrically conductive material 124a″, sputtered on the surface of the multiple-micropore body 123a, is deposited again.

Thus, electrically conductive material is replenished from the electrically conductive material replenishing section 121 to the electrically conductive material replenished section 122. This allows the surface of the multiple-micropore body 123a to be formed with the micropores 124a in an electrically conducting state with the electrically conductive material replenishing section 121 such that the discharging distance 201 is maintained in a fixed value at all times.

Further, like the micropore 124a′″, if no electrically conductive material is filled in the micropore 124a since the beginning, a spark discharge begins to occur passing through the micropore 124a. This causes the surface of the electrically conductive material replenishing section 121 to be eroded due to the occurrence of cathode sputtering. In due course, the micropore 124 is filled with electrically conductive materials 125a and 124a′, formed in melted states, or electrically conductive atom 124a′ scattered due to cathode sputtering. This allows the spark discharge to occur on the surface of the electrically conductive material replenished section 122, enabling the discharging distance to be fixed.

### Second Embodiment

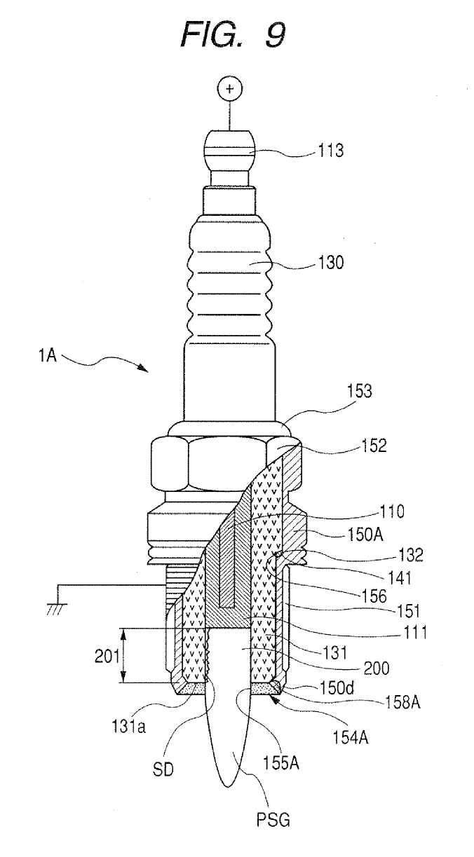

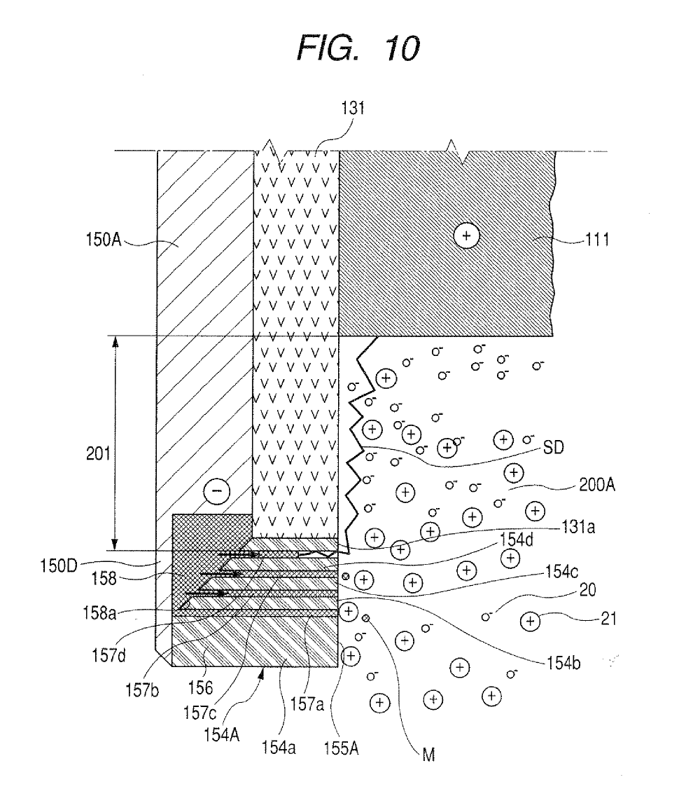

A plasma type ignition plug 1A of a second embodiment according to the present invention will be described below in detail with reference to FIGS. 9 and 10 and FIGS. 11A to 11C.

For the present embodiment, the circuit structure, shown in FIG. 2B, is employed to drive the plasma type ignition plug 1A, In this case, the center electrode 110 acts as a positive electrode and the ground electrode 154A acts as a negative electrode.

The center electrode 110 has an outer circunmferentially formed with a surface portion 111. A spark discharge occurs between the surface portion 111 of the center electrode 110 and a surface of an opening portion 155A of the ground electrode 154A.

The plasma type ignition plug 1A of the present embodiment has the same fundamental structure as that of the first embodiment shown in FIG. 1 with like reference characters designating like or corresponding component parts to omit redundant description and description will be made of the present embodiment with a focus on distinctive features.

With the plasma type ignition plug 1A of the present embodiment, the center electrode surface portion 111 charges positively. Therefore, only electrons in plasma gas impinge upon the center electrode surface portion 111 and no cations with heavy mass collides therewith. This results in improvement in durability of the center electrode 110.

Moreover, a metal shell 150A has a bottom distal end 150d formed with an electrically conductive material replenishing section 158 held in electrical contact with the ground electrode 154A, formed in a disc-like structure covering a bottom end face 131a of the leading end portion 131 of the porcelain insulator 130, which forms a discharging distance fixing member that suppresses a wear of the ground electrode 154A due to cathode sputtering.

Referring to FIG. 9, an essential part of the plasma type ignition plug 1A of the second embodiment will be described below in detail in conjunction with advantageous effects.

The metal shell 150 has a distal end 150d provided with the electrically conductive material replenishing section 158 in electrical contact with the ground electrode 154A. The ground electrode 154A, acting as the discharging distance fixing member, includes an electrically conductive material replenished section 156, held in contact with an slanted surface 58a of the electrically conductive material replenishing section 158, and a plurality of micropores 157 radially extending from the slanted surface 15a of the electrically conductive material replenishing section 158 to a ground-electrode opening portion 155A to be exposed to a discharging space 200A.

The electrically conductive material replenished section 156 is comprised of a multiple-micropore body that is formed in a substantially annular shape using insulating material. The plurality of micropores 157 radially extends through the multiple-micropore body from the electrically conductive material replenishing section 158 to the discharging space 200A.

Thus, the plurality of micropores 157 is held in electrically conducting state with the slanted surface 158a of the electrically conductive material replenishing section 158. This allows a surface discharge SD to occur between a surface of the micropore 157 and the center electrode 110 so as to creep on an inner circumferential surface of the leading end portion 131 of the porcelain insulator 130. When this takes place, a large amount of electrons 21 are released and nitrogen or the like becomes cations 20.

This causes a gas mixture in the discharging space 200A to be formed in a plasma state with high temperature and high pressure under an electrically neutral state.

Like the micropores 124a of the multiple-micropore body 123a forming the discharging distance fixing member 120 of the plasma type ignition plug 1 of the first embodiment shown in FIGS. 3A and 3B, the micropores 157 may be preferably filled with electrically conductive material such as, for instance, Ag, Au, Ni, Pt or the like or electrically conductive ceramic material such as, for instance, TiN, MoSiO₂ or the like. In an alternative, the micropores 157 may preferably remain intact in opened states.

With the micropore 157 remaining in opened states, the surface discharge SD occurs along a path inside the micropore 157, thereby enabling a spark discharge to occur between the slanted surface 158a of the electrically conductive material replenishing section 158 and the surface of the center electrode 110.

Further, even if electrically conductive material M of the micropores 157 is scattered in the discharging space 200A due to cathode sputtering electrically conductive material is replenished from the electrically conductive material replenishing section 158 to the electrically conductive material replenished section 156, enabling a discharge voltage to be kept in a nearly constant level.

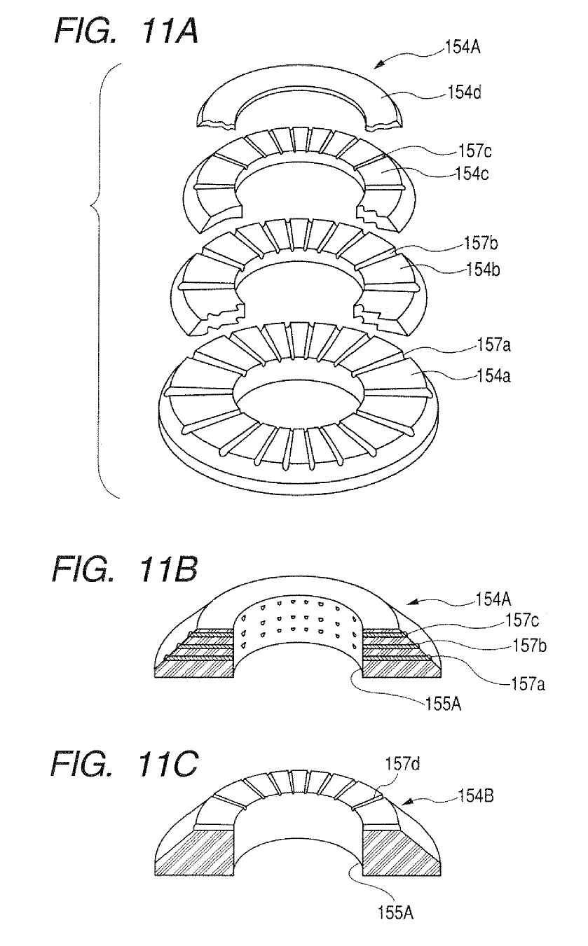

A detailed structure of the discharging distance fixing member 154A is shown in FIGS. 11A to 11C.

As shown in FIG. 11A, the discharging distance fixing member 154A includes a plurality of annular discharging distance fixing members 154a to 154c, each made of insulating material and formed in a nearly trapezoidal shape in cross section, which are formed with plurality of radially extending recesses 157a, 157b and 157c, respectively. The annular discharging distance fixing members 154a to 154c are stacked in a unitary structure and an annular discharging distance fixing member 154d is placed on top of the unitary structure, enabling the formation of the discharging distance fixing member 154A as shown in FIG. 8B.

Further, the discharging distance fixing member 154A may be preferably structured to include a stack of the annular discharging distance fixing members 154a to 154c like the embodiment shown in FIGS. 9 and 11A. In an alternative, the discharging distance fixing member 154A may be replaced by a single-layered discharging distance fixing member 154B3 that has a surface, facing a boundary portion between the bottom distal end face 131a of the leading end portion 131 of the porcelain insulator 130 and a base end portion of the discharging distance fixing member 154B, which is formed with a plurality of radially extending recesses 157d.

### Third Embodiment

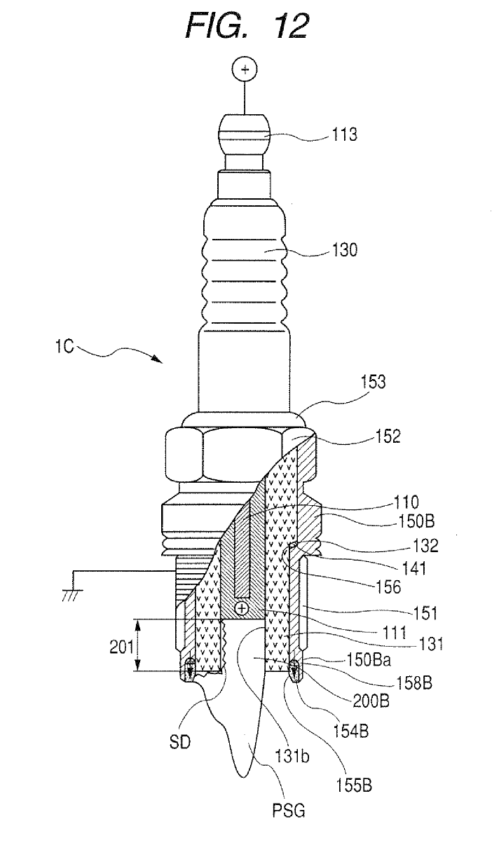

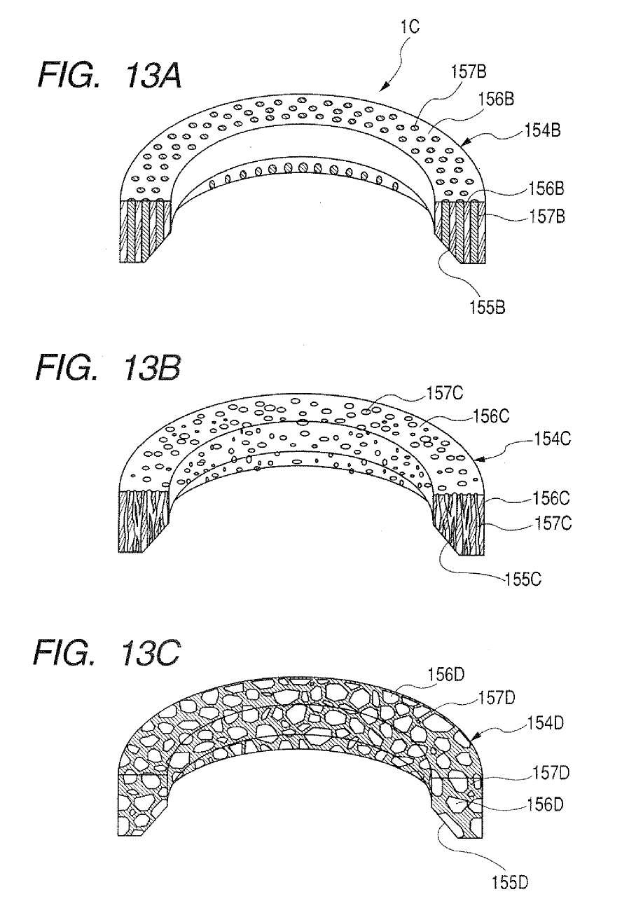

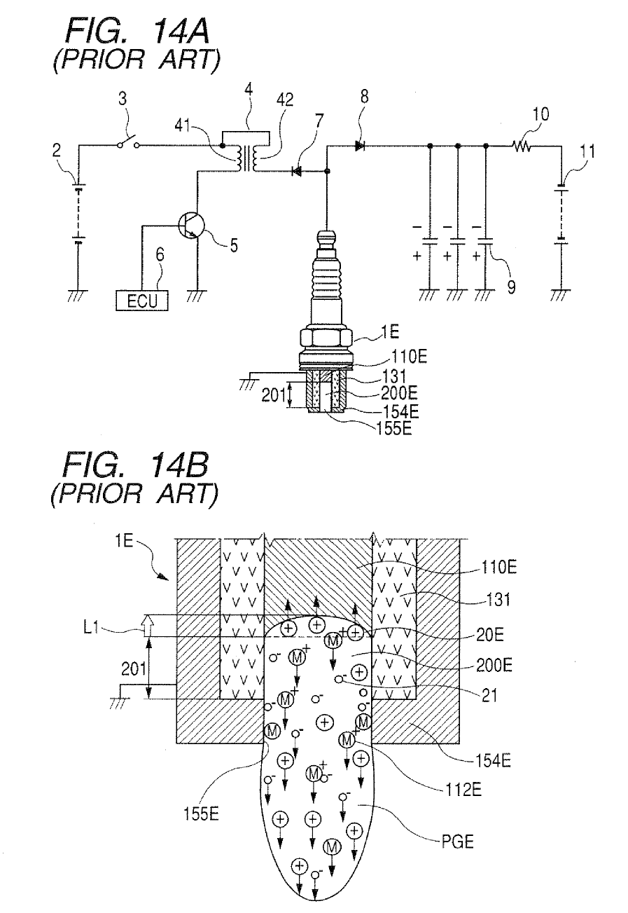

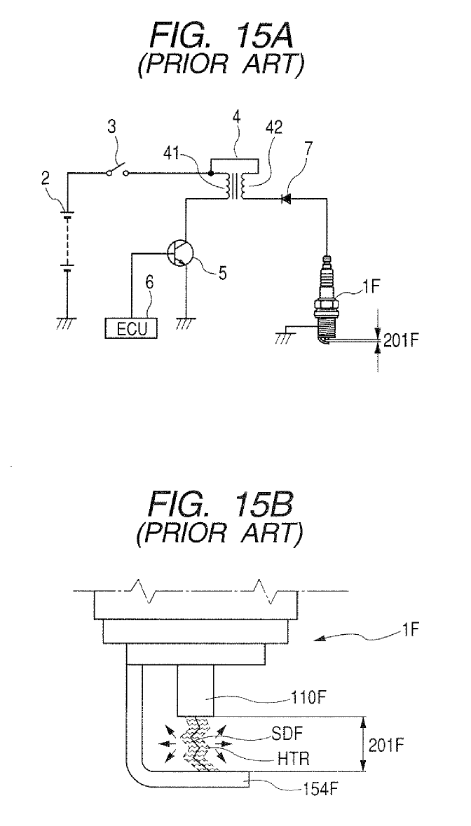

A plasma type ignition plug 1C of a third embodiment according to the present invention will be described below in detail with reference to FIG. 12 and FIGS. 13A to 13C.

For the present embodiment, the circuit structure, shown in FIG. 21B is employed to drive the plasma type ignition plug 1C in this case, the center electrode 110 acts as a positive electrode and a ground electrode 154B acts as a negative electrode. The center electrode 110 has the outer circumferentially formed with the surface portion 111. A spark discharge occurs between the surface portion 111 of the center electrode 110 and a surface of an opening portion 155B of the ground electrode 154B.

With the plasma type ignition plug 1C of the present embodiment, a metal shell so 150B has a distal end 150Ba provided with an electrically conductive material replenishing section 158B in electrical contact with a ground electrode 154B.

Further, the ground electrode 154B has an opening 155B with a diameter greater than that of the leading end portion 131 of the porcelain insulator 130 but to be nearly equal to an outer diameter of the leading end portion 131 of the porcelain insulator 130.

With such a structure, electrode material is liable to be scattered due to cathode sputtering with scattered electrode material being adhered onto an inner circumferential periphery 131b of the leading end portion 131 of the porcelain insulator 130 in an area facing a discharging space 200B at a position close proximity to the center electrode 110, causing a spark discharge to occur in an instable manner.

However, like the structure of the present embodiment, the opening portion 155B of the ground electrode 1541B is opened in an area radially wider than the leading end portion 131 of the porcelain insulator 130, resulting in a reduction in the amount of electrode material being scattered even to an area inside the discharging space 200B. This results in a spark discharge to occur in a stable manner.

Detailed structures of the discharging distance fixing member 154B are shown in FIGS. 13A to 13C.

FIG. 13A shows the discharging distance fixing member 154B formed in a structure composed of a multiple-micropore body; FIG. 13B shows a discharging distance fixing member 154C formed in a structure composed of a porous body; and FIG. 13C shows a discharging distance fixing member 154D formed in a structure composed of a sintered mixture body.

As shown in FIG. 13A, the discharging distance fixing member 154B includes the multiple-micropore body 156B, made of insulating material and formed with plurality of axially extending recesses 157B and plays a role as an electrically C0 conductive material replenished section.

As shown in FIG. 13A, the micropores 157B may be preferably filled with electrically conductive material such as, for instance, Ag, Au, Ni, Pt or the like in electrical contact with the distal end 150Ba of the metal shell 150B.

In an alternative shown in FIG. 13B, the discharging distance fixing member 154C, made of the porous body 156C, has a large number of axially extending micropores 157C and plays a role as an electrically conductive material replenished section.

As shown in FIG. 13C, the discharging distance fixing member 154D includes a conductive material replenished section 156D, comprised of a multiple-micropore body formed in a mixed sintered body between insulating ceramic material such as, for instance, Si₃N₄ and Al₂O₃ or the like and electrically conductive ceramic material such as, for instance, TiN and MoSiO₂ or the like, which plays a role as an electrically conductive material replenished section.

Like the first and second embodiments, the structures shown in FIGS. 13A to 13C have similar advantageous effects. That is, even if cathode sputtering occurs on a surface of each of the ground-electrode opening portions 155B to 155D of the structures shown in FIGS. 13A to 13C, electrically conductive material is replenished from the electrically conductive material replenishing section 158B to each of the electrically conductive material replenished sections 156B, 156C and 156D. Thus, no increase occurs in a discharge voltage, enabling the plasma type ignition plug 1C to be realized with high durability.

While the specific embodiments of the present invention have been described above in detail, it will be appreciated by those skilled in the art that various modifications and alternatives to those details could be developed in light of the overall teachings of the disclosure. Accordingly, the particular arrangement disclosed are meant to be illustrative only and not limited to the scope of the present invention.

For instance, with the plasma type ignition plug 1 of the first embodiment, the electrically conductive material replenished section is formed in a thickness of approximately 0.5 mm. In this case, if the electrically conductive material replenished section has a thickness that is too thin, a material transfer can be easily performed from the electrically conductive material replenishing section to the electrically conductive material replenished section. However, there is likelihood in that the erosion easily occurs due to cathode sputtering. On the contrary, if the electrically conductive material replenished section has a thickness that is too thick, a material transfer becomes hard to occur from the electrically conductive material replenishing section to the surface of the electrically conductive material replenished section.

Accordingly, the electrically conductive material replenished section may preferably have a thickness suitably adjusted depending on an internal combustion engine to be used.

What is claimed is:

1. A plasma type ignition plug for igniting an internal combustion engine, comprising:
a cylindrical ground electrode having a leading end whose bottom portion has a central area formed with an opening portion;
a cylindrical insulating body, kept in abutting contact with an inside of the ground electrode and engaging the bottom portion of the ground electrode, which has an inner diametric portion defining a discharging airspace in communication with the opening portion of the ground electrode; and
a center electrode fitted to the insulating body at a center thereof and having a leading end exposed to the discharging airspace at a position axially inward from a leading end face of the ground electrode, either one of the ground electrode and the center electrode serving as a negative electrode and the other serving as a positive electrode;
wherein a voltage is applied across the ground electrode and the center electrode to initiate a spark discharge in the discharging airspace formed inside the insulating body to allow gas in the discharging airspace to eject from the opening portion of the ground electrode in a plasma state at a high temperature and high pressure for achieving an ignition in the internal combustion engine; and
a discharging distance fixing member, including an electrically conductive material replenishing section, made of an electrically conductive material available to melt when subjected to a heat of the gas in the plasma state, and an electrically conductive material replenished section to which the electrically conductive material is replenished, which is covered on a surface of the negative electrode for initiating the spark discharge between a surface of the discharging distance fixing member and the positive electrode so as to avoid a fluctuation in a spark discharge distance caused by a wear of the negative electrode clue to a collision of gas in the plasma state.

2. The plasma type ignition plug according to claim 1, wherein:
the discharging distance fixing member is located such that the discharging airspace and the electrically conductive material replenished section are adjacent to each other and the electrically conductive material replenishing section and the electrically conductive material replenished section are adjacent to each other.

3. The plasma type ignition plug according to claim 1, wherein:
the electrically conductive material replenished section comprises a sintered mixture body between an insulating material and an electrically conductive material.

4. The plasma type ignition plug according to claim 1, wherein:
the electrically conductive material replenished section comprises a multiple-micropore body having a large number of micropores extending from a surface of the electrically conductive material replenishing section to a surface exposed to the discharging airspace.

5. The plasma type ignition plug according to claim 1, wherein:
the electrically conductive material replenished section comprises a porous body having a large number of irregularly shaped open voids.

6. The plasma type ignition plug according to claim 1 wherein:
the electrically conductive material replenished section is made of at least one of an insulating material and an electrically conductive material with a high melting point.

7. The plasma type ignition plug according to claim 4, wherein:
the large number of micropores have a shape formed in at least one of a circular shape, a hexagonal shape, square shape and a recessed shape.

8. The plasma type ignition plug according to claim 1, wherein:
the electrically conductive material for use in the electrically conductive material replenishing section includes at least one of a transition metallic material, selected from the group consisting of Pt, Au and Ag, and a compound of the transition metallic material.

9. The plasma type ignition plug according to claim 6, wherein:
the insulating material for use in the electrically conductive material replenished section includes a ceramic material composed of at least one of Si₃N₄ and Al₂O₃.

10. The plasma type ignition plug according to claim 6, wherein:
the electrically conductive material with the high melting point for use in the electrically conductive material replenished section includes a HfC ceramic material.
